(19) United States
(12) Patent Application Publication
(10) Pub. No.: US 2006/0001755 A1
(43) Pub. Date: Jan. 5, 2006

(54) Solid state imaging device

(75) Inventors: Koichi Sato, Saitama (JP); Iwao Takemoto, Chiba (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/156,454

(22) Filed: Jun. 21, 2005

(30) Foreign Application Priority Data
Jun. 30, 2004 (JP) P2004-193086

(51) Int. Cl. H04N 5/335

(52) U.S. Cl. 348/308; 348/302

(57) ABSTRACT

A solid state imaging device is provided that comprises a photoelectric conversion element, a capacitor, a transfer transistor, a reset transistor, an amplifier transistor, and an electrical conductor. The solid state imaging device has a light receiving surface comprising plural pixels. The photoelectric conversion element generates an electrical charge according to the received light amounts. The capacitor receives the electrical charge from the photoelectric conversion element. The reset transistor sweeps out the electrical charge stored in the capacitor. The amplifier transistor outputs a pixel signal according to a voltage of the capacitor. The select-line connects with a main electrode of the amplifier transistor. Through the select-line, either the ON-signal or the OFF-signal flows. The ON-signal makes an amplifier transistor output the pixel signal. The OFF-signal makes the amplifier transistor stop outputting the pixel signal.

### BACKGROUND OF THE INVENTION

1. Field of the Invention

The present invention relates to a solid state imaging device, in which the area of the photoelectric conversion element is able to be enlarged or is able to be reduced.

2. Description of the Related Art

A CMOS solid state imaging device, manufactured by using a CMOS LSI manufacturing process is known as a prior art imaging device having an XY address system. The CMOS solid state imaging device is specialized in that it is able to incorporate various electronic devices in each pixel. Each pixel generates an electrical charge in accordance with a received light amount.

A prior art CMOS imaging device comprises four transistors in each pixel. One transistor is used to transfer the electrical charge stored in a photodiode into a floating diffusion. Another transistor is used to sweep out the electrical charge stored in the floating diffusion. Another transistor is used to output a pixel signal according to the electrical charge stored in the floating diffusion. The other transistor is used to control the timing to output the pixel signal from each pixel. Each pixel should have the same functions performed by the above transistors so that the CMOS imaging device can work.

On the other hand, it is generally preferable from the point of view of a lower noise and a larger dynamic range, or a miniaturized imaging device that the portion of the photodiode area is large in each pixel.

### SUMMARY OF THE INVENTION

Therefore, an object of the present invention is to enlarge an area of a photodiode in each pixel without losing the above functions.

According to the present invention, a solid state imaging device comprises a photoelectric conversion element, a capacitor, a transfer transistor, a reset transistor, an amplifier transistor, and an electrical conductor. The solid state imaging device has a light receiving surface comprising a plurality of pixels. Each pixel comprises a photoelectric conversion element, a capacitor, a transfer transistor, a reset transistor, and an amplifier transistor. The photoelectric conversion element generates an electrical charge according to an amount of light received by the photoelectric conversion element. The photoelectric conversion element stores the electrical charge. The capacitor receives the electrical charge from the photoelectric conversion element. The capacitor generates a voltage in accordance with the received electrical charge. The transfer transistor transfers the electrical charge stored in the photoelectric conversion element to the capacitor. The reset transistor sweeps out the electrical charge stored in the capacitor. The amplifier transistor outputs a pixel signal according to the voltage. The electrical conductor is connected to a main electrode of the amplifier transistor. An ON signal or OFF signal flows alternately through the electrical conductor. The ON signal makes the amplifier transistor output the pixel signal. The OFF signal makes the amplifier transistor stop outputting the pixel signal.

Further preferably, a solid state imaging device should comprise a power controller. The power controller alternately supplies power, the ON signal, to the electrical conductor and supplies no power, the OFF signal, to the electrical conductor.

Further preferably, a main electrode of the reset transistor also may be connected to the electrical conductor.

Furthermore preferably, the capacitor may comprise a floating diffusion.

Further still, the electrical conductor may comprise a conductive line.

### BRIEF DESCRIPTION OF THE DRAWINGS

The objects and advantages of the present invention will be better understood from the following description, with reference to the accompanying drawings in which:

FIG. 1 schematically illustrates a structure of a first embodiment;

FIG. 2 illustrates a circuit structure of the pixel 21 of a first embodiment;

FIG. 3 is a timing-chart of a movement of the imaging device;

FIG. 4 illustrates a circuit structure of the pixel of a prior art imaging device; and

FIG. 5 illustrates a circuit structure of the pixel 210 of a second embodiment.

### DESCRIPTION OF THE PREFERRED EMBODIMENTS

The present invention is described below with reference to the embodiments shown in the drawings.

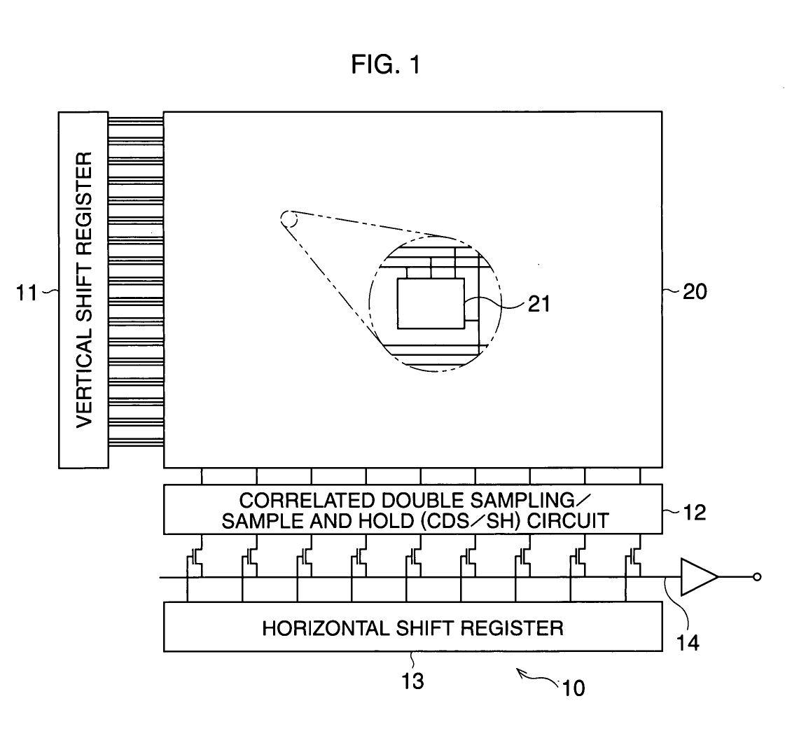

FIG. 1 schematically illustrates a structure of a first embodiment.

The CMOS solid state imaging device 10 comprises an imaging block 20, a vertical shift register 11, a correlated double sampling/sample and hold (CDS/SH) circuit 12, a horizontal shift register 13, and a horizontal output line 14. A vertical shift register 11 is directly connected to an imaging block 20. A horizontal output line 14 is connected to an imaging block 20 through a CDS/SH circuit 12.

Plural pixels 21 are arranged at a light receiving surface of the imaging block 20 in a matrix. A signal charge is generated in each pixel 21. The set of pixel signals that is generated in all the pixels 21 on the light receiving surface, comprise an image signal corresponding to the image of the photographed object. A pixel signal is output from each pixel 21 one by one. The vertical shift register 11 and the horizontal shift register 13 are used to select the pixel 21 that outputs a pixel signal.

The vertical shift register 11 selects a horizontal line, that is the row of the pixel 21 that will output a signal. The CDS/SH circuit 12 performs a correlated double sampling of a pixel signal from the pixels 21 in the row selected by the vertical shift register 11. The horizontal shift register 13 selects the pixel signal sampled and held by the CDS/SH circuit 12, and then the pixel signal is output to the horizontal output line 14. Then the pixel signal is transferred to the computer for signal processing through the horizontal output line 14. The computer processes the pixel signal according to some image processes, and the pixel signal is transformed to the image signal.

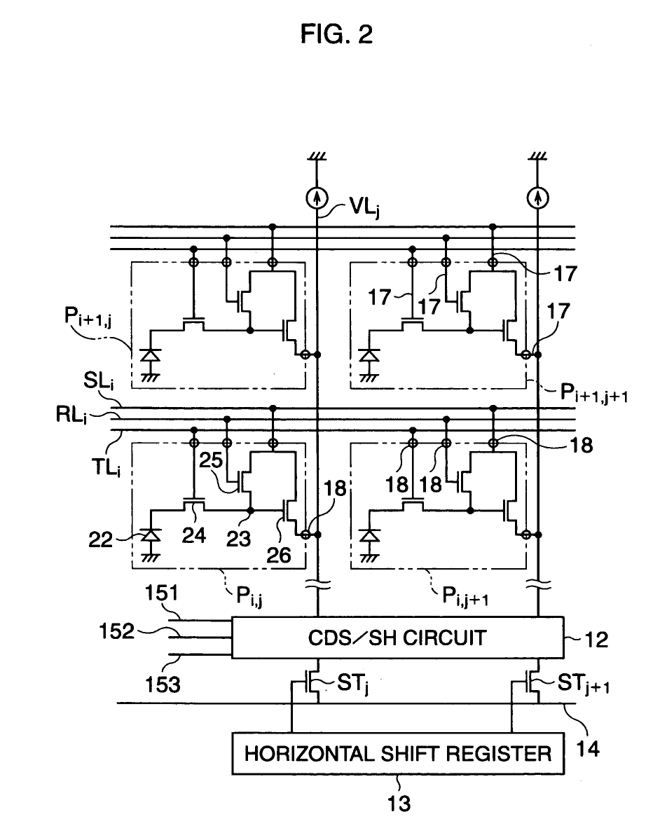

FIG. 2 illustrates a circuit structure of the pixel 21 of a first embodiment.

The structure of a pixel which is arranged in row i and column j, hereinafter referred to as P_{i,j}, is explained in the following description, and the structure of the other pixels is the same as that of the pixel P_{i,j}.

The pixel P_{i,j} comprises a photodiode (PD) 22, a floating diffusion (FD) 23, a transfer transistor 24, a reset transistor 25, and an amplifier transistor 26.

An electrical charge is generated at the PD 22 according to an amount of light received by the pixel P_{i,j}. The PD 22 stores the generated electric charge.

A source and a drain of the transfer transistor 24 are respectively connected to the PD 22 and the FD 23. A gate of the transfer transistor 24 of the pixel P_{i,j} is connected to a transfer-signal-line of row i, hereinafter referred to as TLᵢ, in this example.

The transfer-signal-line TLᵢ runs horizontally between the pixel P_{i,j} and the pixel P_{i+1,j}. An ON and an OFF signal shaped pulse pattern flow alternately through the transfer-signal-line TLᵢ. The transfer-signal-line TLᵢ is connected to the vertical shift register 11. The vertical shift register 11 controls the timing of the output of the ON and OFF signal to the transfer-signal-line TLᵢ.

When the ON signal flows through the transfer-signal-line TLᵢ, the transfer transistor 24 of the pixel P_{i,j} transfers the electrical charge from the PD 22 to the FD 23. The FD 23 is a capacitor. The FD 23 generates a voltage in accordance with the received electrical charge.

A source and a drain of the reset transistor 25 of the pixel P_{i,j} are respectively connected to FD 23 and a select-line of row i, hereinafter referred to as SLᵢ. A gate of the reset transistor 25 of the pixel P_{i,j} is connected to a reset-signal-line of row i, hereinafter referred to as RLᵢ.

The select-line SLᵢ and the reset-signal-line RLᵢ run horizontally between the pixel P_{i,j} and the pixel P_{i+1,j}. An ON and an OFF signal pulse pattern flow alternately through the reset-signal-line RLᵢ. The reset-signal-line RLᵢ, is connected to the vertical shift register 11. The vertical shift register 11 controls the timing of the output of the ON and OFF signal to the reset-signal-line RLᵢ.

When the ON signal flows through the reset-signal-line RLᵢ, the reset transistor 25 of the pixel P_{i,j} sweeps out the charge stored by FD 23 to the select-line SLᵢ. And then the voltage of the FD 23 of the pixel P_{i,j} is reset to the voltage of the select-line SLᵢ. The reset-signal-line RLᵢ is connected to the vertical shift register 11.

A gate and a source of the amplifier transistor 26 of the pixel P_{i,j} are respectively connected to the FD 23 and a vertical output line of column j, hereinafter referred to as VLⱼ. A drain of the amplifier transistor 26 of the pixel P_{i,j} is connected to the select-line SLᵢ with the reset transistor 25.

The vertical output line VLⱼ runs vertically between the pixel P_{i,j} and the pixel P_{i,j+1}. The vertical output line VLⱼ is connected to the CDS/SH circuit 12.

An ON and an OFF signal pulse pattern flows alternately the select-line SLᵢ. The ON signal for the select-line SLᵢ indicates that power is being supplied to the amplifier transistor. On the other hand, the OFF signal for the select-line SLᵢ indicates that the supply of power has been shut off. The select-line SLᵢ is connected to the vertical shift register 11. The vertical shift register 11 controls the timing of the output of the ON and OFF signal to the select-line SLᵢ.

When the ON signal flows through the select-line SLᵢ, power is input to the amplifier transistor 26 of the pixel P_{i,j}. Then a voltage is applied between the drain and the source of the amplifier transistor 26. By the application of voltage to the amplifier transistor 26, the amplifier transistor 26 is activated and this enables the amplifier transistor 26 to output a voltage signal in accordance with the voltage of the FD 23, to the vertical output line VLⱼ.

The ON signal flowing through the select-line SLᵢ is a trigger signal to start the output of the pixel signal from the amplifier transistor 26 of the pixel P_{i,j}. The OFF signal flowing through the select-line SLᵢ is a stopper signal to stop outputting the pixel signal.

The CDS/SH circuit 12 samples and holds the signal voltage output from the amplifier transistor 26. The CDS/SH circuit 12 is connected to a first sample-hold (SH) line 151, a second SH line 152, and a third SH line 153, through which alternate ON and an OFF signals flow. The first, second, and third SH lines 151, 152, and 153 are connected to the vertical shift register 11. The vertical shift register 11 controls the timing of the output of the ON and OFF signals to the first, second, and third SH lines 151, 152, and 153.

When the ON signal flows through the first SH line 151, the CDS/SH circuit 12 samples and holds the signal voltage as a first signal corresponding to a voltage of the FD 23, when the FD is reset.

When the ON signal flows through the second SH line 152, the CDS/SH circuit 12 samples and holds the signal voltage as a second signal, corresponding to a voltage of the FD 23, when the FD 23 receives the signal charge transferred from the PD 22.

When the ON signal flows through the third SH line 153, the CDS/SH circuit 12 generates a third signal by subtracting the second signal from the first signal, and holds the third signal.

An output terminal of the CDS/SH circuit 12 is connected to a source of a select transistor of column j, hereinafter referred to as STⱼ. A drain and a gate of the select transistor STⱼ are respectively connected to the horizontal output line 14 and the horizontal shift register 13.

The horizontal shift register 13 outputs an ON and an OFF signal pulse pattern to the gate of the select transistor STⱼ. When the ON signal is input to the gate of the select transistor STⱼ, the third signal held at the CDS/SH circuit 12 is output to the horizontal output line 14.

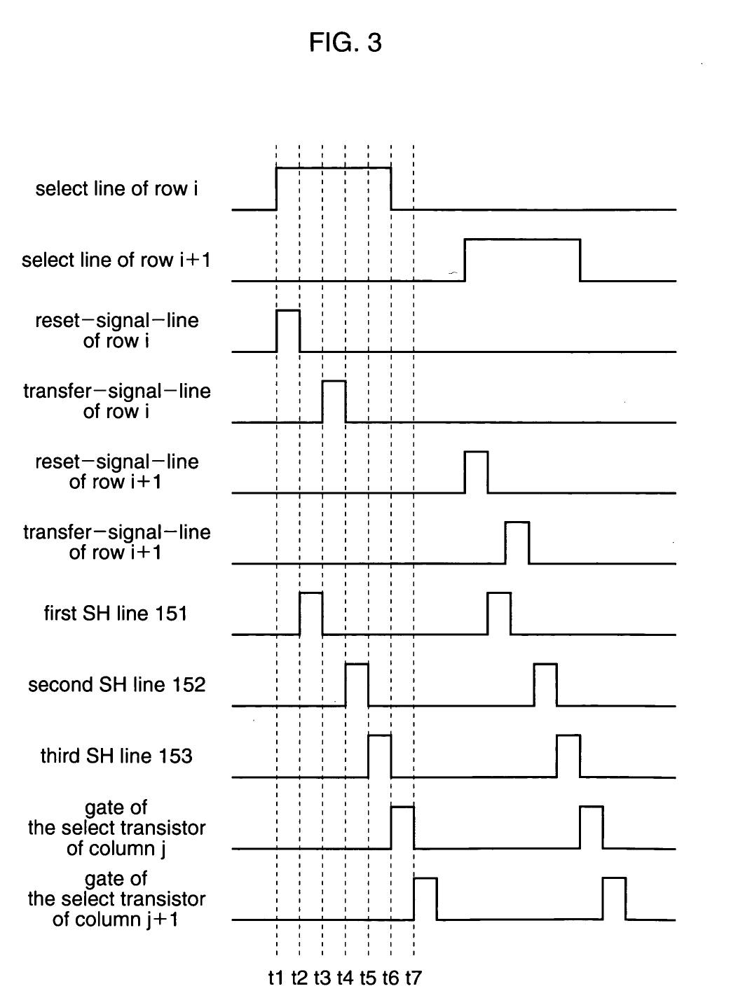

The data transfer process of the above embodiment is described below with reference to FIG. 3, which is a timing-chart of the data output process of the imaging device 10.

At the time t1, the amplifier transistor 26 of the pixel P_{i,j} is switched on, and then the amplifier transistor 26 outputs a signal voltage from the pixel P_{i,j}. At the same time, a voltage of the FD 23 of the pixel P_{i,j} is reset to the voltage of the select-line SLᵢ by switching on the reset transistor 25 of the pixel P_{i,j}.

At the time t2, the reset transistor 25 of the pixel P_{i,j} is switched off. At the same time, the vertical shift register 11 outputs the ON signal to the first SH line 151. And then the CDS/SH circuit 12 samples and holds the first signal corresponding to the reset voltage of the FD 23.

At the time t3, the vertical shift register 11 outputs the OFF signal to the first SH line 151. Then sampling and holding of the first signal finishes. At the same time, the transfer transistor 24 of the pixel P_{i,j} is switched on. And then the transfer transistor 24 transfers the electrical charge from the PD 22 to the FD 23. The FD 23 stores the electrical charge.

At the time t4, the transfer transistor 24 of the pixel P_{i,j} is switched off. At the same time, the vertical shift register 11 outputs the ON signal to the second SH line 152. And then the CDS/SH circuit 12 samples and holds the second signal corresponding to the voltage of the FD 23 storing the charge.

At the time t5, the vertical shift register 11 outputs the OFF signal to the second SH line 152. Then sampling and holding of the second signal finishes. At the same time, the vertical shift register 11 outputs the ON signal to the third SH line 153. And then the CDS/SH circuit 12 generates and holds the third signal, which is the difference between the first and the second signals.

At the time t6, the vertical shift register 11 outputs the OFF signal to the third SH line 153. And the amplifier transistor 26 of the pixel P_{i,j} is switched off. At the same time, the select transistor SLⱼ is switched on. Arid then the third signal held at the CDS/SH circuit 12 is output to another device, such as a computer for signal processing, through the horizontal output line 14.

At the time t7, the output of the third signal from the pixel P_{i,j} finishes. At the same time, the output of the third signal from the pixel P_{i,j+1} starts. The pixel P_{i,j+1} is located in row i and column j+1, next to the pixel P_{i,j}.

After outputting all the third signals from the pixels 21 in the row i, the third signals from the pixels 21 in the row i+1 start to be output. All third signals are output from all pixels 21 in the imaging block 20 by carrying out the same process for outputting the third signal from the pixel P_{i,j}.

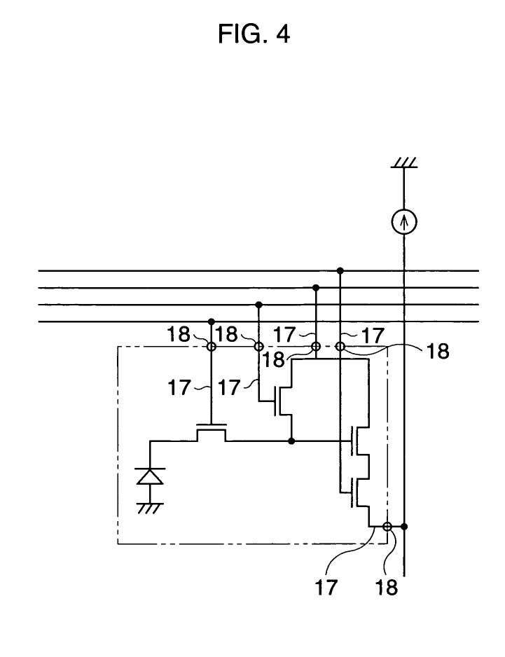

A transistor for row selection is not necessary in the above embodiment because each pixel 21 is able to be selected to output the pixel signal by switching on the amplifier transistor 26. Consequently, a transistor for row selection can be left out when compared to the prior art imaging device shown in FIG. 4.

This means the area for PD 22 can be broadened to cover the area used for the transistor for row selection in each pixel 21. Further, this contributes to noise reduction and the enlargement of dynamic range owing to the broadening of the area of PD 22.

Or an area of each pixel 21 can be reduced. Consequently, the imaging device 10 can be miniaturized or the number of pixels 21 in an imaging device 10 can be increased owing to the reduction of the area of each pixel 21.

The number of connection lines 17 for connecting each pixel with the control lines (SLᵢ, RLᵢ, TLᵢ) and the output line (VLⱼ) is four in the first embodiment, while it is five in the prior art CMOS imaging device shown in FIG. 4. The number of through-holes 18 for passing the connection lines 17 from each pixel 21 can be reduced. Consequently, the area of PD 22 can be further broadened owing to the reduction of connection lines 17 and through-holes 18.

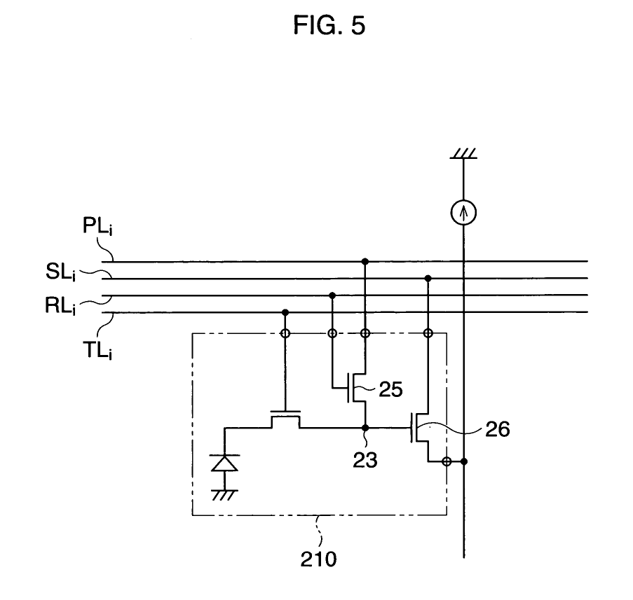

FIG. 5 illustrates a circuit structure of the pixel 210 of a second embodiment. Features having the same function as that of the first embodiment are given the same symbol as in the first embodiment.

The power line of row i, hereinafter referred to as PLᵢ, runs horizontally between two pixels arranged vertically. The voltage of the power line PLᵢ is kept at a fixed voltage.

A drain of the amplifier transistor 26 is connected to a select-line SLᵢ. A drain of the reset transistor 25 is connected to a power line PLᵢ. When the reset transistor is switched on, the voltage of the FD 23 is reset to the voltage of the power line PLᵢ. The other structures are same as those of the first embodiment.

Transistor for row selection is also not needed in the second embodiment. Consequently, an area of the PD 22 in each pixel can be broadened.

In the first and second embodiments, the transistors 24, 25, and 26 in each pixel and the select transistor STⱼ are n-channel type. But the present invention is adaptable to p-channel transistors by changing the polarity of the electrical potential when connecting to each transistor 24, 25, 26, and 16ⱼ. A main electrode, that is a drain or source, of the amplifier transistor 26 is connected to the select-line SLᵢ even if the amplifier transistor 26 is n-channel or p-channel.

In the first and second embodiments, a floating diffusion is applied. But the present invention is adaptable to any kind of capacitor, which can receive an electrical charge and generate a voltage.

In the first and second embodiments, a select-line is applied. But the present invention is adaptable to any kind of electrical conductor.

In the first and second embodiments, the pixels in the imaging block are arranged in a matrix, but the present invention is adaptable to any arrangement in two dimensions.

In the first and second embodiments, the imaging device is a CMOS imaging device, but the present invention is adaptable to any other imaging device, which comprises an XY address.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2004-193086 (filed on Jun. 30, 2004), which is expressly incorporated herein, by reference, in its entirety.

1. A solid state imaging device, comprising:
A photoelectric conversion element that generates an electrical charge according to light amounts received by said photoelectric conversion element, and that stores said electrical charge;
a capacitor that receives said electrical charge from said photoelectric conversion element, to generate a voltage in accordance with said electrical charge;
a transfer transistor that transfers said electrical charge stored in said photoelectric conversion element to said capacitor;
a reset transistor that sweeps out said electrical charge stored in said capacitor;
an amplifier transistor that outputs a pixel signal according to said voltage; and
an electrical conductor that is connected to a main electrode of said amplifier transistor and where an ON-signal making said amplifier transistor output said pixel signal and an OFF-signal making said amplifier transistor stop outputting said pixel signal, flow alternately;
wherein a light receiving surface comprises plural pixels comprising said photoelectric conversion element, said capacitor, said transfer transistor, said reset transistor, and said amplifier transistor.

2. A solid state imaging device according to claim 1, further comprising a power controller that alternately supplies power, said ON-signal, to said electrical conductor and no power, said OFF-signal to said electrical conductor.

3. A solid state imaging device according to claim 1, wherein a main electrode of said reset transistor is connected to said electrical conductor.

4. A solid state imaging device according to claim 1, wherein said capacitor comprises a floating diffusion.

5. A solid state imaging device according to claim 1, wherein said electrical conductor comprises a conductive line.
